(19) United States
(12) Patent Application Publication
(10) Pub. No.: US 2024/0334871 A1
(43) Pub. Date: Oct. 10, 2024

(54) Brush Cutters

(71) Applicant: Milwaukee Electric Tool Corporation, Brookfield, WI (US)

(72) Inventors: Brian Lee, Brookfield, WI (US); Tabrez Mahamad, Brookfield, WI (US)

(21) Appl. No.: 18/622,106

(22) Filed: Mar. 29, 2024

Related U.S. Application Data
(60) Provisional application No. 63/457,542, filed on Apr. 6, 2023.

(51) Int. Cl. A01D 34/90; A01D 34/76; A01D 34/82

(52) U.S. Cl. CPC A01D 34/90; A01D 34/76; A01D 34/824

(57) ABSTRACT

Brush cutters are provided. A brush cutter includes a handle assembly and a working head assembly. The working head assembly includes a working implement and a bevel pinion extending from a first end to a bevel end, wherein the bevel end is functionally coupled to the working implement, wherein the bevel pinion is supported in a cavity by a first bearing and a second bearing disposed around an outer surface of the bevel pinion, and wherein the first bearing and the second bearing are separated by a gap. The brush cutter further includes a shaft extending at least partly between the handle assembly and the working head assembly; and a motive device operable to rotate the bevel pinion for actuating the working implement.

### FIELD

The present disclosure relates generally to brush cutters, and more particularly, to mechanical support features for brush cutters.

### BACKGROUND

Power tools are generally used to perform manual operations while reducing the required amount of manual labor. For example, brush cutters, trimmers, edges or the like (collectively referred to herein as brush cutters) can be utilized for trimming grass, weeds, brush, or shrubs. Brush cutters generally utilize a working implement such as a trimmer line or blade which is spun at high speeds to break the foliage. Actuation of the tool implement can be selectively actuated by an operator using a trigger or other similar device. However, the brush cutter may become heavy for an operator to hold over an extended period of operation. Moreover, as brush cutters increase in size and power, stresses may increase at one or more locations along the shaft or interconnected components.

Accordingly, alternative mechanical support features for brush cutters which provide greater operational control or mechanical integrity would be welcome in the art.

### BRIEF DESCRIPTION

Aspects and advantages of the invention in accordance with the present disclosure will be set forth in part in the following description, or may be obvious from the description, or may be learned through practice of the technology.

In accordance with one embodiment, a brush cutter is provided. The brush cutter includes a handle assembly and a working head assembly. The working head assembly includes a working implement and a bevel pinion extending from a first end to a bevel end, wherein the bevel end is functionally coupled to the working implement, wherein the bevel pinion is supported in a cavity by a first bearing and a second bearing disposed around an outer surface of the bevel pinion, and wherein the first bearing and the second bearing are separated by a gap. The brush cutter further includes a shaft extending at least partly between the handle assembly and the working head assembly; and a motive device operable to rotate the bevel pinion for actuating the working implement.

In accordance with another embodiment, a brush cutter includes a handle assembly; a working head assembly includes a working implement; a shaft extending at least partly between the handle assembly and the working head assembly; a motive device operable to actuate the working implement; and a clip assembly releasably securable to the brush cutter. The clip assembly includes a first base portion; a second base portion pivotably connected to the first base portion, wherein the first base portion and the second base portion define an interior cavity for receiving the brush cutter; a loop pivotably connected to the first base portion; and a stopper configured to limit a maximum degree of rotation of the loop with respect to the first base portion.

In accordance with another embodiment, a brush cutter is provided. The brush cutter includes a handle assembly; and a working head assembly. The working head assembly includes a working implement; and a bevel gearcase. The brush cutter further includes a shaft extending at least partly between the handle assembly and the working head assembly, wherein the shaft extends into the bevel gearcase; a tubular shim disposed between the shaft and the bevel gearcase; and a motive device operable to actuate the working implement.

In accordance with another embodiment, a handle assembly for a brush cutter is provided. The handle assembly includes an elongated pole terminating at an end face; and a grip at least partially surrounding the elongated pole and the end face, wherein the grip comprises a protrusion that extends from an interior surface of the grip into the end face of the elongated pole to resist rotation of the grip relative to the elongated pole.

In accordance with another embodiment, a brush cutter is provided. The brush cutter includes a handle assembly including an elongated pole terminating at an end face; and a grip at least partially surrounding the elongated pole and the end face, wherein the grip comprises a protrusion that extends from an interior surface of the grip into the end face of the elongated pole to resist rotation of the grip relative to the elongated pole. The brush cutter further includes a working head assembly including a working implement; and a bevel pinion extending from a first end to a bevel end, wherein the bevel end is functionally coupled to the working implement, wherein the bevel pinion is supported in a cavity by a first bearing and a second bearing disposed around an outer surface of the bevel pinion, and wherein the first bearing and the second bearing are separated by a gap. The brush cutter further includes a shaft extending at least partly between the handle assembly and the working head assembly; a motive device operable to rotate the bevel pinion for actuating the working implement; and a clip assembly releasably securable to the brush cutter. The clip assembly includes a first base portion; a second base portion pivotably connected to the first base portion, wherein the first base portion and the second base portion define an interior cavity for receiving the brush cutter; a loop pivotably connected to the first base portion; and a stopper configured to limit a degree of rotation of the loop with respect to the first base portion.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a brush cutter in accordance with embodiments of the present disclosure;

FIG. 2 is a perspective view of a handle assembly for a brush cutter in accordance with embodiments of the present disclosure;

FIG. 3 is a perspective view of a clip assembly for a brush cutter in accordance with embodiments of the present disclosure;

FIG. 4 is a side view of the clip assembly of FIG. 3 with a loop pivoting between a first position and a second position in accordance with embodiments of the present disclosure;

FIG. 5 is an internal cross sectional view of the clip assembly of FIG. 3 in accordance with embodiments of the present disclosure;

FIG. 6 is an internal cross sectional view of a portion of a working head assembly for a brush cutter in accordance with embodiments of the present disclosure;

FIG. 7 is another internal cross sectional view of a portion of a working head assembly in accordance with embodiments of the present disclosure;

FIG. 8 is a perspective view of a working head assembly in accordance with embodiments of the present disclosure; and

FIG. 9 is a perspective view of a working head assembly with a bevel gearcase removed in accordance with embodiments of the present disclosure.

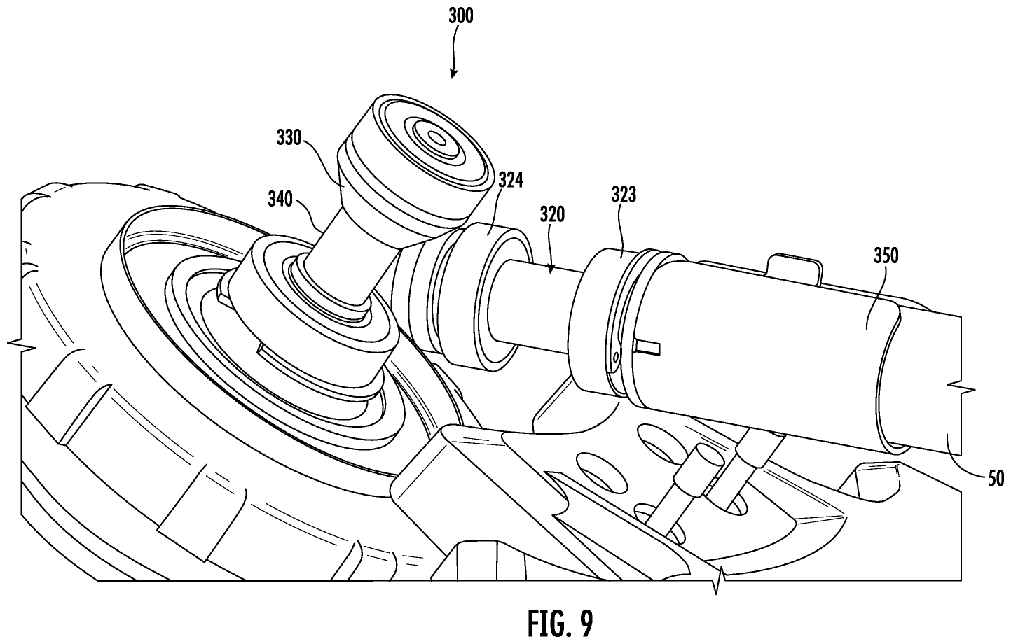

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes.” “including.” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or Bis satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the term “power tool” is intended to refer to a device which is used to perform a work operation, such as cutting grass, weeds, brush, shrubs, or the like. By way of non-limiting example, power tools can include brush cutters, trimmers, edgers, hedge trimmers, string trimmers, cutters or the like. While embodiments provided below are directed to brush cutters, one or more components of the brush cutters described below, such as the handle assembly, clip assembly, or working head assembly, may be utilized with one or more different types of power tools.

As used herein, the term “actuate” and its variants are intended to refer to any physical manipulation of a component. Actuation can include, for example, rotating, reciprocating, translating, or otherwise moving a component such as a working tool (e.g., string, blades, disks, or the like).

As used herein, the term “functionally coupled” and its variants are intended to refer to any direct or indirect connection between two more components for the transfer of motion therebetween. Functionally coupled can include, for example, two directly adjacent components that are mechanically engaged with one another such that when one component moves (e.g., rotates), the other component is caused to move as well. Functional coupled can also include, for example, two components that are connected via one or more intervening components, such that motion of one components is transferred to the second component via the one or more intervening components (e.g., one or more intervening gears, shafts, or the like).

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Brush cutters and other power tools provide a power assisted tool for completing a task by an operator. For instance, a brush cutter may include a motive device functionally connected to a working implement. The motive device can be selectively activated by the operator to selectively actuate (e.g., rotate) the working implement. As brush cutters and other power tools increase in size and power, ease of use may decrease while mechanical stresses may increase.

In general, brush cutters described in accordance with one or more embodiments herein include a housing, a handle assembly, and a working head assembly. The brush cutter can incorporate one or more components to facilitate the handling and operation of the brush cutter. For instance, the handle assembly may include one or more handles that have one or more protrusions extending from a grip into the end face of an elongated pole that is supporting the grip. The one or more protrusions can prevent or reduce rotation of the grip with respect to the elongated pole. Moreover, the brush cutter may include a clip assembly with a pivotable loop for supporting external attachments, such as a harness. The clip assembly can include a stopper to mechanically limit the degree of rotation of the loop. Further, the working head assembly can include one or more components to facilitate the functional connection between a motive device and a working implement. For instance, the working head assembly may include a bevel pinion that is supported by a first bearing and a second bearing separated by a gap. By separating the first and second bearing, a load induced by the working head assembly can be better distributed. The working head assembly can further include a tubular shim to help fill a void in the working head assembly, such as between a bevel gearcase and a shaft. These support features, whether alone or in combination, can increase the ease of operation by the operator, and improve the structural integrity of the overall brush cutter by increasing the distribution of loads.

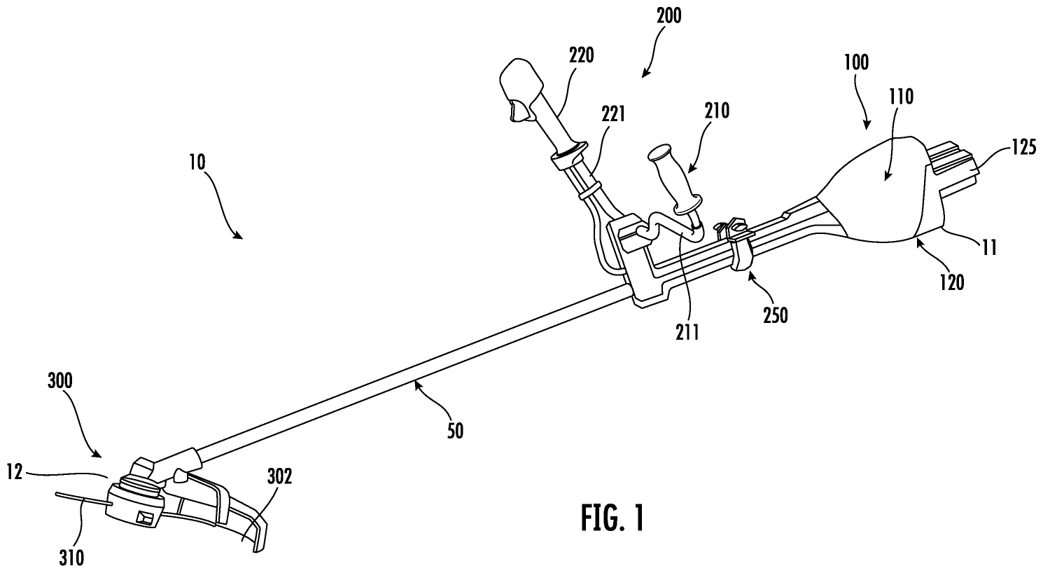

Referring now to the drawings, FIG. 1 illustrates a brush cutter 10 generally including a housing 100, a handle assembly 200, and a working head assembly 300. A shaft 50 extends between two or more of the components of the brush cutter 10, such as extending at least partly between the handle assembly 200 and the working head assembly 300. While the illustrated apparatus is generally referred to herein as a “brush cutter,” it should be appreciated that this is a term of convenience and can additionally, or alternatively, constitute a trimmer, edger, hedge trimmer, string trimmer, cutter, or other similar device or power tool with alternative nomenclature.

In this regard, the working head assembly 300 can include a working implement 310 that can be utilized for trimming grass, weeds, brush, shrubs, or the like. The working head assembly 300 and working implement 310 can comprise a variety of different types of tools such as, for example, a blade, a string line, a disk, a cutter or the like. For example, in some embodiments, the working implement 310 for the brush cutter 10 can constitute a disk with an exterior sharpened edge and potentially one or more teeth. The working head assembly 300 can thereby spin the disk at a high rate of speed to cut debris. In some embodiments, the brush cutter 10 can constitute a trimmer line wherein the working implement 310 is an elongated string extending from a central body. The working head assembly 300 can thereby spin its central body, and thus the elongated string, at a high rate of speed to cut debris. While certain types of brush cutters 10 are explicitly disclosed herein, it should be appreciated that these are not intended to be limiting and other embodiments may further be realized within the scope of this disclosure.

The brush cutter 10 can include the housing 100, the handle assembly 200, and the working head assembly 300 in a variety of configurations. For instance, as illustrated in FIG. 1, the brush cutter 10 may generally extend from a first end 11 to a second end 12. In such embodiments, the housing 100 may generally be disposed about the first end 11 of the brush cutter 10, while the working head assembly 300 is disposed about the second end 12 of the brush cutter 10. The handle assembly 200 can be disposed between the first end 11 and the second end 12 of the brush cutter 10 as illustrated.

Moreover, the housing 100, the handle assembly 200, and the working head assembly 300 may comprise discrete components, or may be combined with one another. For instance, as illustrated in FIG. 1, the handle assembly 200 may directly extend from the housing 100. In such embodiments, the shaft 50 may thereby extend away from the handle assembly 200 and towards the working head assembly 300. However, in some embodiments, the handle assembly 200 may be located at a point along the shaft 50 that is separate from the housing. In even some embodiments, the housing 100 may be disposed between the handle assembly 200 and the working head assembly 1300.

In some embodiments, the brush cutter 10 can further include a guard 302 configured to protect the operator from flying debris kicked up by the working head assembly 300. In certain instances, the guard 302 can be engaged with the shaft 50 and be disposed adjacent to the working head assembly 300.

With continued reference to FIG. 1, the housing 100 can include one or more components to facilitate the operation of the brush cutter 10. For instance, in some embodiments, the brush cutter 10 can include a motive device 110 such as an electric motor or a gas engine. The housing 100 of the brush cutter 10 may thereby include the motive device 110. In other embodiments, the motive device 110 may be positioned elsewhere about the brush cutter 10, such as separate from, or away from, the housing 100.

The housing 100 may additionally, or alternatively, include a power source for the motive device. For instance, as illustrated in FIG. 1, the housing 100 can include a battery receiving area 120 which receives a battery 125 to power an electric motor. Alternatively, or additionally, the housing 100 may include a fuel tank for storing gasoline to power a gas engine. Using the power source, the motive device 110 can thereby drive the working head assembly 300, such as by causing the working implement 310 of the working head assembly 300 to rotate.

While FIG. 1 illustrates the housing 100 as including the battery receiving area 120 with a battery 125, in addition to housing the motive device 110, the housing may additionally, or alternatively, include a variety of other components for operating the brush cutter 10. For instance, the housing 100 may include one or more displays, user interfaces, or other parts.

The brush cutter 10 can further include the handle assembly 200. The handle assembly 200 can include one or more handles to assist a user in picking up, holding, maneuvering, and/or operating the brush cutter 10. The handle assembly 200 can be located at any suitable location along the brush cutter 10. For instance, as illustrated in FIG. 1, the handle assembly 200 may extend from the housing 100 and be disposed between the housing 100 and the working head assembly 300. In other embodiments, the handle assembly 200 may extend from the housing 100 in a different direction, or be positioned elsewhere on the brush cutter 10 such as behind the housing 100 such that the housing 100 is between the handle assembly 200 and the working head assembly 300. In some embodiments, the brush cutter 10 may include multiple handle assemblies 200, such as one at the first end 11 of the brush cutter 10, and one between the housing 100 and the working head assembly 300.

The handle assembly 200 can include, for example, one or more handles that extend away from the brush cutter. For instance, as illustrated in FIG. 1, the handle assembly 200 may include a first handle 210 on a first elongated pole 211 and a second handle 220 on a second elongated pole 221.

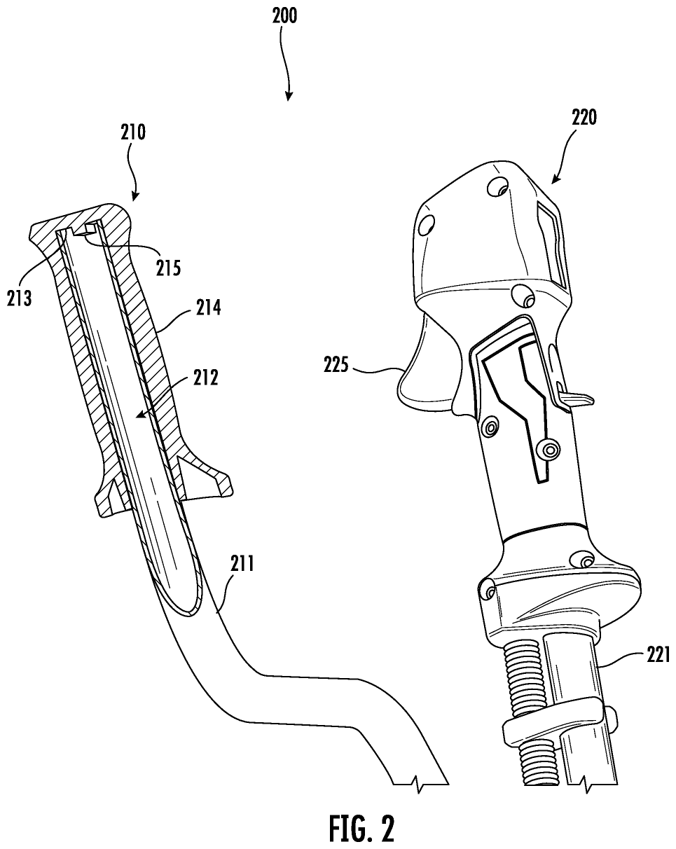

With additional reference to FIG. 2, an enlarged view of the handle assembly 200 is illustrated comprising the first handle 210 and the second handle 220. The first handle 210, the second handle 220, or any other handle can be used by an operator to hold and/or control the brush cutter 10.

For instance, in some embodiments, the handle assembly 200 may include a grip 214 for facilitating an operator holding the brush cutter 10. That is, as illustrated in FIG. 2, the first handle 210 may include the first elongated pole 211 that defines an interior 212 (e.g., a hollow interior) and terminates at an end face 213. The end face 213 may comprise a solid, or substantially solid face. The first handle 210 may further include a grip 214 that at least partially surrounds the first elongated pole 211 and the end face 213. The grip 214 can comprise one or more materials or contours that are conducive to holding by an operator. For instance, the grip 214 may comprise a rubber or foam material. Moreover, the grip may comprise a contoured grip, such as one that is shaped to receive a hand wrapped around the grip 214.

The first handle 210 may further include one or more features to prevent or limit rotation of the grip 214 with respect to the first elongated pole 211. For instance, as illustrated in FIG. 2, the grip 214 may include a protrusion 215 that extends from an interior surface of the grip 214 into the end face 213 of the first elongated pole 211. By mechanically interconnecting the grip 214 with the first elongated pole 211 via the protrusion 215, the grip 214 may be secured in place without being rotatable about the first elongated pole 211. That is, the protrusion 215 may resist rotation of the grip 214 relative to the first elongated pole 211.

In some embodiments, the protrusion 215 may comprise an asymmetrical shape. For instance, the protrusion 215 may have a width or a length that is longer than the other, such as an elongated ridge or a rectangular box. The asymmetrical shape can assist in resisting rotation by not being rotatable in a hole in the end face 213 that is complimentary to the shape of the protrusion 215.

In some embodiments, the grip 214 may comprise a plurality of protrusions 215 that extend from the interior surface of the grip 214 into the end face 213 of the first elongated pole 211. For instance, the grip 214 may include three or more protrusions 215 that extend into or through the end face 213 of the first elongated pole 211 such that the plurality of protrusions 215 collectively resist rotation of the grip 214 relative to the first elongated pole 211.

While the grip 214 is illustrated on the first handle 210 of the handle assembly 200, it should be appreciated that the handle assembly 200 may also include one or more additional grips, such as on one or more additional handles, without deviating from the scope of the present disclosure.

Still referring to FIG. 2, the handle assembly 200 may include the second handle 220 that is configured the same as, or different than, the first handle 210. For instance, in some embodiments, bot the first handle 210 and the second handle 220 may each include a grip, with or without anti-rotation features. In some embodiments, such as that illustrated in FIG. 2, the second handle 220 may include one or more control features for controlling the operation of the brush cutter 10 (FIG. 1). For instance, the second handle 220 can include an actuator 225 that allows the operator to selectively control the brush cutter 10. The control features can further include other controls which permit the operator to effect change to the brush cutter 10. For instance, by way of non-limiting example, the control features on the handle assembly 200 may include any one or more of a cruise control feature allowing the operator to maintain the operating speed of the working head assembly, a turbo which allows the brush cutter 10 to reach full operational speed, a power switch having at least ON and OFF functionality, a safety switch, or any other desirable user controls.

With reference back to FIG. 1, the brush cutter 10 may include one or more additional features to assist an operator supporting the brush cutter 10. For instance, in some embodiments, the brush cutter 10 may include a clip assembly 250. The clip assembly 250 may generally provide an anchor point that one or more additional support components can be releasably attached to. For instance, the clip assembly 250 may include a location that a harness (not illustrated) can be releasably clipped to. The harness may then be wrapped around the operator to help distribute the load of the brush cutter 10.

In some embodiments, such as that illustrated in FIG. 1, the clip assembly 250 can be disposed on the brush cutter 10 on or around the handle assembly 200, such as between the handle assembly 200 and the housing 100. In some embodiments, the clip assembly 250 may be disposed around the shaft 50, such as between the handle assembly 200 and the working head assembly 300. In even some embodiments, the brush cutter 10 may include a plurality of clip assemblies 250 at one or more locations, such as on or around the shaft 50, the handle assembly 200, and/or the housing 100.

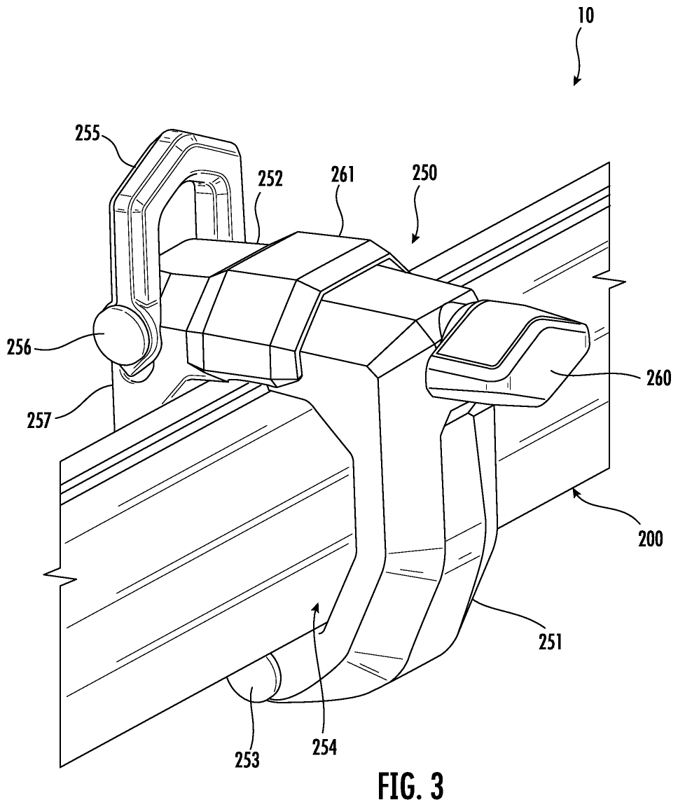

With reference to FIG. 3, a perspective view of the clip assembly 250 is illustrated around a portion of the brush cutter 10, such as the handle assembly 200. The clip assembly 250 can include a first base portion 251 and a second base portion 252 that are pivotably connected to one another. That is, for example, the second base portion 252 can be pivotably connected to the first base portion 251 at a pivotable connection 253.

The first base portion 251 and the second base portion 252 combine to define an interior cavity 254. The interior cavity 254 can comprise any size and shape suitable for receiving the brush cutter 10. For instance, as illustrated in FIG. 3, the interior cavity 254 can be sized and shaped to receive a portion of the handle assembly 200. Alternatively, or additionally, the interior cavity 254 may be sized and shaped to receive the shaft of the brush cutter 10.

The clip assembly 250 can include a loop 255. The loop 255 can provide an attachment point for an exterior component, such as a harness, for use by an operator. For instance, a harness may be worn by an operator that is releasably attachable to the loop 255.

The loop 255 can be pivotably connected to the clip assembly 250, such as by being pivotably connected to the second base portion 252 of the clip assembly 250 at a pivotable connection 256. The clip assembly 250 can further include a stopper 257 that is configured to limit the degree of rotation of the loop 255, such as with respect to the second base portion 252.

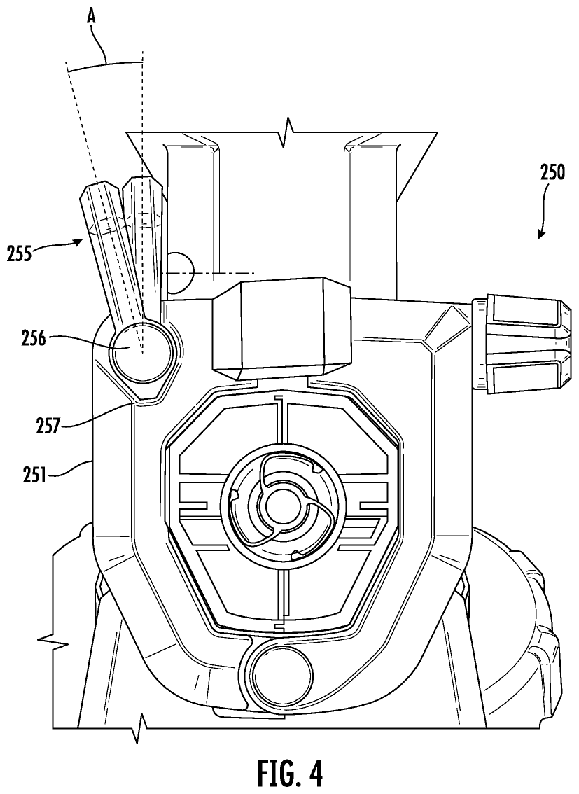

With reference to FIG. 4, a side view of the clip assembly 250 is illustrated with the loop 255 being pivoted between a first position and a second position to illustrate its maximum angle of rotation A. As illustrated, the loop 255 can be pivotably connected to the first base portion 251 of the clip assembly 250 at the pivotable connection 256. However, the stopper 257 can be configured to limit the maximum angle of rotation A about the pivotable connection 256. That is, as illustrated in FIG. 4, the loop 255 may only be rotatable between positions that are located along a maximum angle of rotation A, such that the loop 255 can not rotate any further beyond the restricted positions. When the loop 255 reaches an end position, the stopper 257 can abut against the clip assembly 250, such as the second base portion 252 of the clip assembly 250, to restrict any further rotation of the loop 255.

Limiting the maximum angle of rotation A of the loop 255 can assist the operator by preventing the repositioning of the brush cutter 10 into an unwanted position, or by preventing the component attached to the loop 255 (e.g., harness) from interfering with other components of the brush cutter. In some embodiments, the maximum angle of rotation A of the loop 255 about the pivotable connection 256 may be 20 degrees or less. In some embodiments, the maximum angle of rotation A of the loop 255 about the pivotable connection 256 may be 15 degrees or less. In even some embodiments, the maximum angle of rotation A of the loop 255 about the pivotable connection 256 may be 10 degrees or less.

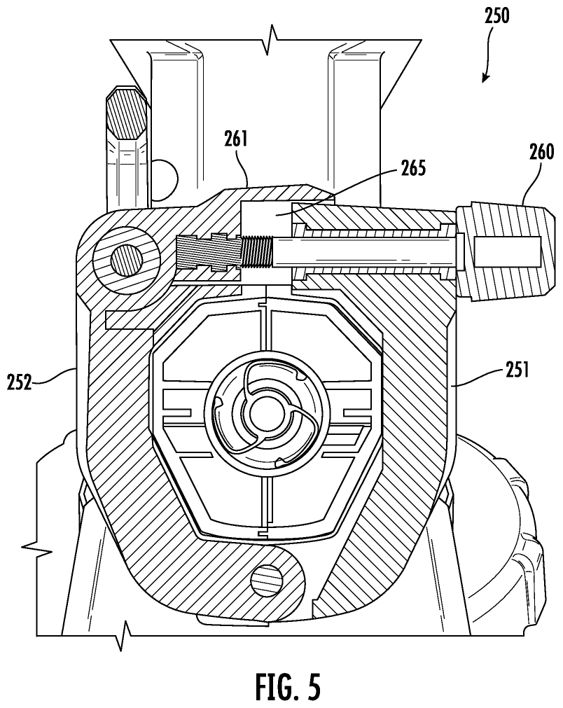

With reference to FIG. 5, an interior view of the clip assembly 250 is illustrated. The clip assembly 250 can be secured to the brush cutter via a fastener 260. The fastener 260 can comprise any component suitable for releasably securing the first base portion 251 and the second base portion 252 in a closed position around the brush cutter. For instance, as best illustrated in FIGS. 3 and 5, the fastener 260 can comprise a screw with a threaded portion that is received by the second base portion 252 of the clip assembly 250. A shaft of the fastener may extend away from the threaded portion and pass through a cavity in the first base portion 251 of the clip assembly 250. Last, a head of the fastener 260 can remain outside of the first base portion 251 such that a user can tighten the fastener 260 by rotating its head.

In some embodiments, the clip assembly 250 is configured such that a gap 265 remains between and end of the first base portion 251 and an end of the second base portion 252 even when the clip assembly 250 is in the closed configuration (e.g., the fastener 260 is tightened) around the brush cutter. For instance, the first base portion 251 and the second base portion 252 may be sized such that their free ends are not able to touch when wrapped around the brush cutter. The gap 265 can allow for additional clearance around the brush cutter during installation, such as by accommodating potential misfits and providing more tolerance when securing the fastener 260.

In such embodiments, the clip assembly 250 may further comprise an overhang 261 that covers at least a portion of the gap 265. For instance, as best illustrated in FIGS. 3 and 5, the overhang 261 may extend from the first base portion 251, over the gap 265, and partially over the second base portion 252. The overhang 261 may thereby visually block the gap 265 and/or reduce the amount of debris interacting with the exposed portion of the fastener 260.

While the clip assembly 250 illustrated in FIGS. 3-5 is presented as a two-piece structure, it should be appreciated that other configurations may also be realized within the scope of this disclosure. For instance, the clip assembly 250 may comprise three or more different pieces that are connected via one or more joints. Likewise, while the illustrated clip assembly 250 comprises a fastener 260 that passes through the first base portion 251 and into the second base portion 252, an alternative installation direction may also be realized.

With reference back to FIG. 1, the brush cutter 10 may include one or more components to functionally connect the motive device 110 to the working implement 310. That is, the brush cutter 10 may include one or more components to translate motion from the motive device 110 to actuate (e.g., rotate) the working implement 310.

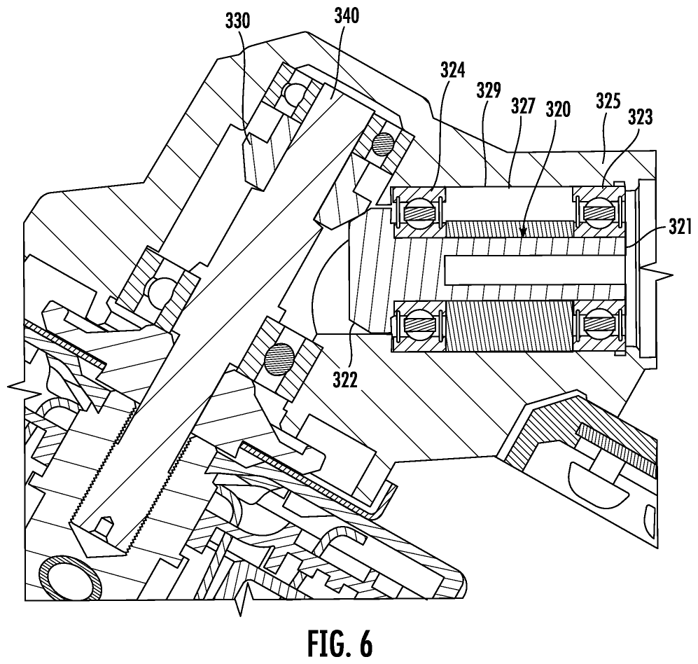

With reference to FIG. 6, an interior cross sectional view of the working head assembly 300 is illustrated, such as for use with the brush cutter 10 illustrated in FIG. 1. The working head assembly 300 can comprise a plurality of interconnected components to functionally connect the motive device to the working implement. For instance, as illustrated, the working head assembly 300 can comprise a bevel pinion 320. The bevel pinion 320 can extend from a first end 321 to a bevel end 322. The bevel pinion 320 can be secured to one or more components in the shaft that are, in turn, connected to the motive device. Thus, as the motive device is activated, the bevel pinion 320 may rotate accordingly. In some embodiments, the bevel pinion 320 may extend in a direction substantially parallel to the shaft.

The bevel pinion can be disposed in a cavity 327. The cavity 327 may be formed in the working head assembly 300, in the shaft (FIG. 1), or a combination thereof. For instance, as illustrated in FIG. 6, the working head assembly 300 can comprise a bevel gearcase 325. The bevel gearcase 325 can comprise a structure for containing the bevel pinion 320 and potentially other related components.

To allow for the bevel pinion 320 to rotate within the cavity 327, the bevel pinion 320 can be supported in the cavity 327 by one or more bearings, such as a first bearing 323 and a second bearing 324. The first bearing 323 and the second bearing 324 can be disposed around the outer surface of the bevel pinion 320, such as between the bevel pinion 320 and the bevel gearcase 325.

In some embodiments, the first bearing 323 and the second bearing 324 can be separated by a gap 329. That is, the first bearing 323 and the second bearing 324 may be spaced apart from one another so that they are separated by some distance. For instance, the first bearing 323 may be disposed at the first end 321 of the bevel pinion 320. Additionally, or alternatively, the second bearing 324 may be disposed at the bevel end 322 of the bevel pinion 320. By separating the first bearing 323 and the second bearing 324 by a gap 265, the stress caused by the working head assembly 300 on the rest of the brush cutter 10 (e.g., the bevel gearcase or the shaft) can become more distributed along a greater distance.

Still referring to FIG. 6, the working head assembly 300 can comprise one or more additional components to functionally connect the bevel pinion 320 to the working implement. For instance, the working head assembly 300 may comprise an output shaft 340 secured to the working implement. The working head assembly 300 may further comprise a bevel gear 330 that is connected (e.g., pinned) to the output shaft 340. For instance, the bevel gear 330 may be connected to an exterior surface of the output shaft 340. The bevel gear 330 can be engaged with the bevel pinion 320 for the transfer or rotational energy therebetween. That is, as the bevel pinion 320 is rotated by the motive device, the bevel pinion 320 will rotate the bevel gear 330. In turn, since the output shaft 340 is connected to the bevel gear 330, the output shaft 340 will also rotate. Last, the working implement 310 will actuate (e.g., rotate) as a result of the rotation of the output shaft 340 to which it is secured.

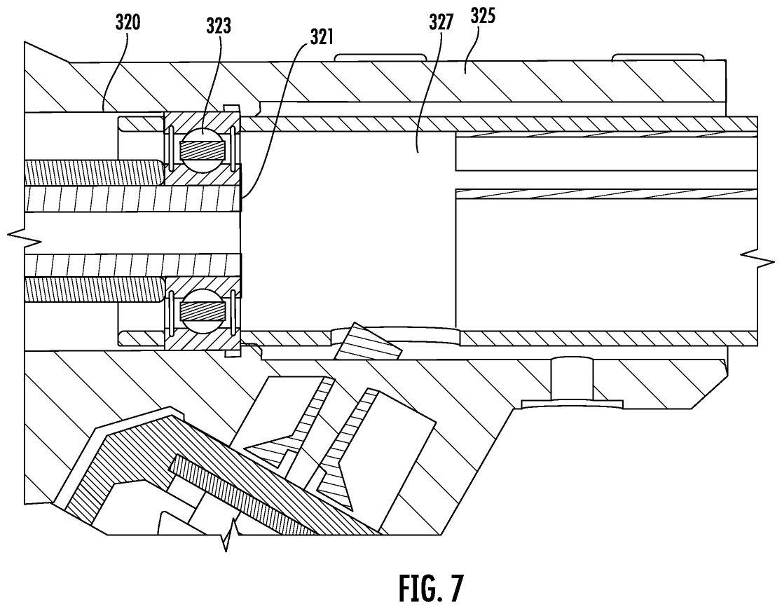

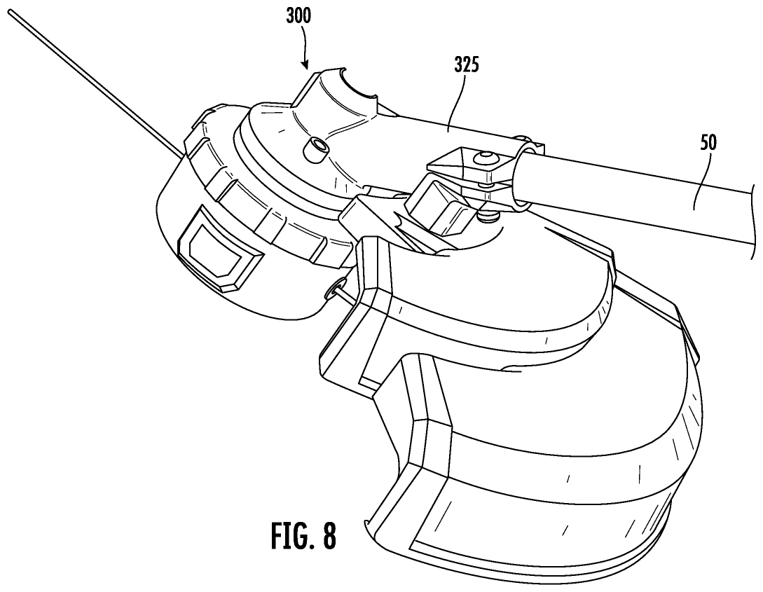

With reference to FIG. 7, an internal cross section of a portion of the working head assembly 300 is illustrated. As a result of the first bearing 323 being separated from the second bearing 324 (FIG. 6), the first bearing 323 may be closer to the first end 321 of the bevel pinion 320. Moreover, the bevel gearcase 325 may define a cavity 327 to accommodate the first bearing 323. However, the cavity 327 may create a gap between the bevel gearcase 325 and the shaft as a result of being sized to accommodate the first bearing 323. For instance, with reference to FIG. 8, an exterior perspective view of the working head assembly 300 is illustrated. As illustrated, the shaft 50 can be inserted into the bevel gearcase 325, which may have a gap between the two components as a result of the bevel gearcase 325 also accommodating the first bearing 323.

With additional reference to FIG. 8, a perspective view of a portion of the working head assembly 300 is illustrated with the bevel gearcase 325 removed. To fill the cavity 327 (FIG. 7) between the shaft 50 and the working head assembly 300 (e.g., the bevel gearcase 325), a tubular shim 350 may be disposed between the shaft 50 and the bevel gearcase 325, or other component of the working head assembly 300. For instance, the tubular shim 350 may be disposed at an end of the shaft 50 that is disposed in the working head assembly 300.

The tubular shim 350 can be secured to an outer surface of the shaft 50, such as through clamping, fastening, or the like. Moreover, the tubular shim 350 may comprise a solid structure and completely cover a portion of the shaft 50, or may comprise a structure with one or more voids (e.g., gaps, holes, slots, or the like) such that the tubular shim 350 only covers a portion of the surface of the shaft 50. The tubular shim 350 can fully or partially fill the space left between the shaft 50 and the working head assembly 300 (e.g., bevel gearcase 325). As a result, the tubular shim 350 can help distribute stress, facilitate a tighter connection, and reduce potential wobbling between respective components.

While various components and features are disclosed herein for brush cutters or other power tools, these features are not mutually exclusive from one another and may be combined in any suitable combination. Moreover, while the power tool is exemplary illustrated as a brush cutter, the power tool may also comprise one or more other types of power tools, or may comprise a brush cutter having one or more other configurations.

Further aspects of the invention are provided by one or more of the following embodiments:

A brush cutter includes a handle assembly and a working head assembly. The working head assembly includes a working implement and a bevel pinion extending from a first end to a bevel end, wherein the bevel end is functionally coupled to the working implement, wherein the bevel pinion is supported in a cavity by a first bearing and a second bearing disposed around an outer surface of the bevel pinion, and wherein the first bearing and the second bearing are separated by a gap. The brush cutter further includes a shaft extending at least partly between the handle assembly and the working head assembly; and a motive device operable to rotate the bevel pinion for actuating the working implement.

The brush cutter of any clause herein, wherein the working head assembly further includes an output shaft secured to the working implement; and a bevel gear connected to an exterior of the output shaft and engaged with the bevel pinion.

The brush cutter of any clause herein, wherein the bevel pinion extends in a direction substantially parallel to the shaft.

The brush cutter of any clause herein, wherein the first bearing is disposed at the first end of the bevel pinion.

The brush cutter of any clause herein, wherein the second bearing is disposed at the bevel end of the bevel pinion.

The brush cutter of any clause herein, wherein the cavity is in the working head assembly.

The brush cutter of any clause herein, wherein the cavity is in the shaft.

The brush cutter of any clause herein, further comprising a tubular shim disposed between the shaft and the working head assembly.

The brush cutter of any clause herein, wherein the tubular shim is disposed at an end of the shaft disposed in the working head assembly.

The brush cutter of any clause herein, wherein the tubular shim is secured onto an outer surface of the shaft.

The brush cutter of any clause herein, further comprising a clip assembly secured to the brush cutter, the clip assembly including a first base portion; a second base portion pivotably connected to the first base portion, wherein the first base portion and the second base portion define an interior cavity for receiving the brush cutter; a loop pivotably connected to the first base portion; and a stopper configured to limit a degree of rotation of the loop with respect to the first base portion.

The brush cutter of any clause herein, wherein the stopper extends from the loop and contacts the first base portion to limit the degree of rotation of the loop.

The brush cutter of any clause herein, further comprising a harness that is releasably securable to the loop.

The brush cutter of any clause herein, wherein the handle assembly includes an elongated pole terminating at an end face; and a grip at least partially surrounding the elongated pole and the end face, wherein the grip comprises a protrusion that extends from an interior surface of the grip into the end face of the elongated pole to resist rotation of the grip relative to the elongated pole.

The brush cutter of any clause herein, wherein the protrusion comprises an asymmetrical shape.

The brush cutter of any clause herein, wherein the handle assembly further includes a second elongated Pole terminating at a second end face; and a second grip at least partially surrounding the second elongated pole at the second end face.

The brush cutter of any clause herein, wherein the second grip comprises an actuator configured to operate the brush cutter.

The brush cutter of any clause herein, wherein the working implement comprises a disk.

The brush cutter of any clause herein, wherein the motive device comprises an electric motor.

A brush cutter includes a handle assembly; a working head assembly comprising a working implement; a shaft extending at least partly between the handle assembly and the working head assembly; a motive device operable to actuate the working implement; and a clip assembly releasably securable to the brush cutter. The clip assembly includes a first base portion; a second base portion pivotably connected to the first base portion, wherein the first base portion and the second base portion define an interior cavity for receiving the brush cutter; a loop pivotably connected to the first base portion; and a stopper configured to limit a maximum degree of rotation of the loop with respect to the first base portion.

The brush cutter of any clause herein, wherein the stopper extends from the loop and contacts the first base portion to limit the maximum degree of rotation of the loop.

The brush cutter of any clause herein, further comprising a harness that is releasably securable to the loop.

The brush cutter of any clause herein, wherein the clip assembly is releasably securable to a portion of the handle assembly.

The brush cutter of any clause herein, wherein the portion of the handle assembly extends in a direction substantially parallel to the shaft.

The brush cutter of any clause herein, wherein the clip assembly is releasable securable to the shaft.

The brush cutter of any clause herein, wherein the maximum degree of rotation is 15 degrees or less.

The brush cutter of any clause herein, wherein a fastener releasably secures the first base portion to the second base portion.

The brush cutter of any clause herein, wherein a gap exists between the first base portion and the second base portion when the fastener secures the first base portion to the second base portion.

The brush cutter of any clause herein, wherein an overhang extends from at least one of the first base portion or the second base portion to at least partially cover the gap.

A brush cutter includes a handle assembly; and a working head assembly. The working head assembly includes a working implement; and a bevel gearcase. The brush cutter further includes a shaft extending at least partly between the handle assembly and the working head assembly, wherein the shaft extends into the bevel gearcase; a tubular shim disposed between the shaft and the bevel gearcase; and a motive device operable to actuate the working implement.

The brush cutter of any clause herein, wherein the working head assembly further comprises a bevel pinion disposed in the bevel gearcase and rotatable by the motive device.

The brush cutter of any clause herein, wherein the bevel gearcase is supported in a cavity of the bevel gearcase by one or more bearings disposed around an outer surface of the bevel pinion.

The brush cutter of any clause herein, wherein the one or more bearings comprises a first bearing and a second bearing separated by a gap.

The brush cutter of any clause herein, wherein the bevel pinion extends from a first end to a bevel end, and wherein the bevel end is functionally coupled to the working implement.

The brush cutter of any clause herein, wherein the first bearing is disposed at the first end of the bevel pinion.

A handle assembly for a brush cutter includes an elongated pole terminating at an end face; and a grip at least partially surrounding the elongated pole and the end face, wherein the grip comprises a protrusion that extends from an interior surface of the grip into the end face of the elongated pole to resist rotation of the grip relative to the elongated pole.

The handle assembly of any clause herein, wherein the protrusion comprises an asymmetrical shape.

The handle assembly of any clause herein, wherein the elongated pole comprises a hollow interior.

The handle assembly of any clause herein, wherein the grip comprises a plurality of protrusions that extend from the interior surface of the grip into the end face of the elongated pole.

The handle assembly of any clause herein, wherein the grip comprises a contoured grip.

The handle assembly of any clause herein, further including a second elongated Pole terminating at a second end face; and a second grip at least partially surrounding the second elongated pole at the second end face.

The handle assembly of any clause herein, wherein the second grip comprises an actuator configured to operate the brush cutter.

The handle assembly of any clause herein, wherein the second grip comprises a second protrusion that extends from an interior surface of the second grip into the second end face of the second elongated pole to resist rotation of the second grip relative to the second elongated pole.

A brush cutter includes a handle assembly including an elongated pole terminating at an end face; and a grip at least partially surrounding the elongated pole and the end face, wherein the grip comprises a protrusion that extends from an interior surface of the grip into the end face of the elongated pole to resist rotation of the grip relative to the elongated pole. The brush cutter further includes a working head assembly including a working implement; and a bevel pinion extending from a first end to a bevel end, wherein the bevel end is functionally coupled to the working implement, wherein the bevel pinion is supported in a cavity by a first bearing and a second bearing disposed around an outer surface of the bevel pinion, and wherein the first bearing and the second bearing are separated by a gap. The brush cutter further includes a shaft extending at least partly between the handle assembly and the working head assembly; a motive device operable to rotate the bevel pinion for actuating the working implement; and a clip assembly releasably securable to the brush cutter. The clip assembly includes a first base portion; a second base portion pivotably connected to the first base portion, wherein the first base portion and the second base portion define an interior cavity for receiving the brush cutter; a loop pivotably connected to the first base portion; and a stopper configured to limit a degree of rotation of the loop with respect to the first base portion.

The brush cutter of any clause herein, further comprising a tubular shim disposed between the shaft and the working head assembly.

The brush cutter of any clause herein, wherein the working head assembly further includes an output shaft secured to the working implement; and a bevel gear connected to an exterior of the output shaft and engaged with the bevel pinion.

The brush cutter of any clause herein, wherein the handle assembly further includes a second elongated pole terminating at a second end face; and a second grip at least partially surrounding the second elongated pole at the second end face.

The brush cutter of any clause herein, wherein the second grip comprises an actuator configured to operate the motive device.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A brush cutter comprising:
a handle assembly;
a working head assembly comprising:
a working implement; and
a bevel pinion extending from a first end to a bevel end,
wherein the bevel end is functionally coupled to the working implement,
wherein the bevel pinion is supported in a cavity by a first bearing and a second bearing disposed around an outer surface of the bevel pinion, and
wherein the first bearing and the second bearing are separated by a gap;
a shaft extending at least partly between the handle assembly and the working head assembly; and
a motive device operable to rotate the bevel pinion for actuating the working implement.

2. The brush cutter of claim 1, wherein the working head assembly further comprises:
an output shaft secured to the working implement; and
a bevel gear connected to an exterior of the output shaft and engaged with the bevel pinion.

3. The brush cutter of claim 1, wherein the bevel pinion extends in a direction substantially parallel to the shaft.

4. The brush cutter of claim 1, wherein the first bearing is disposed at the first end of the bevel pinion.

5. The brush cutter of claim 4, wherein the second bearing is disposed at the bevel end of the bevel pinion.

6. The brush cutter of claim 1, further comprising a tubular shim disposed between the shaft and the working head assembly.

7. The brush cutter of claim 6, wherein the tubular shim is disposed at an end of the shaft disposed in the working head assembly.

8. The brush cutter of claim 6, wherein the tubular shim is secured onto an outer surface of the shaft.

9. The brush cutter of claim 1, further comprising a clip assembly secured to the brush cutter, the clip assembly comprising:
a first base portion;
a second base portion pivotably connected to the first base portion, wherein the first base portion and the second base portion define an interior cavity for receiving the brush cutter;
a loop pivotably connected to the first base portion; and
a stopper configured to limit a degree of rotation of the loop with respect to the first base portion.

10. The brush cutter of claim 9, wherein the stopper extends from the loop and contacts the first base portion to limit the degree of rotation of the loop.

11. The brush cutter of claim 9, further comprising a harness that is releasably securable to the loop.

12. The brush cutter of claim 1, wherein the handle assembly comprises:
an elongated pole terminating at an end face; and
a grip at least partially surrounding the elongated pole and the end face, wherein the grip comprises a protrusion that extends from an interior surface of the grip into the end face of the elongated pole to resist rotation of the grip relative to the elongated pole.

13. The brush cutter of claim 12, wherein the protrusion comprises an asymmetrical shape.

14. The brush cutter of claim 12, wherein the handle assembly further comprises:
a second elongated pole terminating at a second end face; and
a second grip at least partially surrounding the second elongated pole at the second end face.

15. The brush cutter of claim 14, wherein the second grip comprises an actuator configured to operate the brush cutter.

16. A brush cutter comprising:
a handle assembly comprising:
an elongated pole terminating at an end face; and
a grip at least partially surrounding the elongated pole and the end face, wherein the grip comprises a protrusion that extends from an interior surface of the grip into the end face of the elongated pole to resist rotation of the grip relative to the elongated pole;
a working head assembly comprising:
a working implement; and
a bevel pinion extending from a first end to a bevel end,
wherein the bevel end is functionally coupled to the working implement,
wherein the bevel pinion is supported in a cavity by a first bearing and a second bearing disposed around an outer surface of the bevel pinion, and
wherein the first bearing and the second bearing are separated by a gap;
a shaft extending at least partly between the handle assembly and the working head assembly;
a motive device operable to rotate the bevel pinion for actuating the working implement; and
a clip assembly releasably securable to the brush cutter, the clip assembly comprising:
a first base portion;
a second base portion pivotably connected to the first base portion, wherein the first base portion and the second base portion define an interior cavity for receiving the brush cutter;
a loop pivotably connected to the first base portion; and
a stopper configured to limit a degree of rotation of the loop with respect to the first base portion.

17. The brush cutter of claim 16, further comprising a tubular shim disposed between the shaft and the working head assembly.

18. The brush cutter of claim 17, wherein the working head assembly further comprises:
an output shaft secured to the working implement; and
a bevel gear connected to an exterior of the output shaft and engaged with the bevel pinion.

19. The brush cutter of claim 16, further comprising:
a second elongated pole terminating at a second end face; and
a second grip at least partially surrounding the second elongated pole at the second end face.

20. The brush cutter of claim 19, wherein the second grip comprises an actuator configured to operate the motive device.
